(19) United States
(12) Patent Application Publication
(10) Pub. No.: US 2018/0339303 A1
(43) Pub. Date: Nov. 29, 2018

(54) LIQUID SPRAYING DEVICE AND PORTABLE BEAUTY TREATMENT DEVICE

(71) Applicant: Panasonic Intellectual Property Management Co., Ltd., Osaka (JP)

(72) Inventors: Hiroyuki INOUE, Shiga (JP); Aya ISHIHARA, Osaka (JP); Yumi HANATO, Shiga (JP)

(21) Appl. No.: 15/983,643

(22) Filed: May 18, 2018

(30) Foreign Application Priority Data
May 24, 2017 (JP) 2017-102889

(51) Int. Cl. B05B 9/08; B05B 7/24

(52) U.S. Cl. CPC B05B 9/0822; B05B 7/2427

(57) ABSTRACT

A liquid spraying device including a tank configured to store liquid, a spraying device including a discharger configured to discharge the liquid in a form of a mist, a first flow path forming part disposed between the tank and the discharger and forms a first flow path of the liquid, a pump provided midway of the first flow path, and feeds the liquid from the tank toward the discharger, and a second flow path forming part configured to form a second flow path that branches off from the first flow path at a branching position between the pump and the discharger, and returns to tank. The first flow path forming part includes a small sectional-area part between the branching position of the first flow path and the discharger, the small sectional-area part forming a flow path having a sectional area smaller than a sectional area of the second flow path.

### BACKGROUND

### 1. Technical Field

The present disclosure relates to a liquid spraying device, and a portable beauty treatment device equipped with the liquid spraying device.

### 2. Description of the Related Art

Japanese Patent No. 4415014 discloses an electrostatic spraying device configured to spray a liquid composition by electrostatic force. The electrostatic spraying device includes a cartridge containing a liquid composition, and has a configuration in which the liquid composition in the cartridge is sucked up by a gear pump, or the like. The electrostatic spraying device further includes a nozzle and an electrode for spraying the composition by electrostatic force.

### SUMMARY

A portable beauty treatment device, such as a hair dryer and a hair iron, equipped with a liquid spraying device may have a problem that air enters a flow path of liquid, for example, when liquid is added to the liquid spraying device. This may lose stability of a flow of the liquid inside the liquid spraying device. This leads to an impediment to stability of spraying of the liquid. The portable beauty treatment device may take various postures, as being held by a user during use. This also leads to an impediment to stability of spraying of the liquid.

In the case where the liquid to be sprayed is colorless and odorless, for example, it is not easy for the user to confirm whether the liquid is being sprayed. In addition, in the case where a required amount of the liquid for protection or the like of the hair is small, for example, the amount to be sprayed from the portable beauty treatment device is also small, and, as a result, the user may not perceive the spraying of the liquid. Accordingly, it is important to achieve stable spraying of the liquid so as to ensure reliability of, for example, the portable beauty treatment device equipped with the liquid spraying device.

The present disclosure has been made by the inventors of the present application to newly focus on the above problem, and an object of the present disclosure is to provide a liquid spraying device and a portable beauty treatment device equipped with the liquid spraying device capable of stably spraying liquid.

In order to achieve the above object, a liquid spraying device according to an aspect of the present disclosure includes a tank configured to store liquid, a spraying device including a discharger configured to discharge the liquid in a form of a mist, a first flow path forming part that is disposed between the tank and the discharger and forms a first flow path of the liquid, a pump that is provided midway of the first flow path, and feeds the liquid from the tank toward the discharger, and a second flow path forming part configured to form a second flow path that branches off from the first flow path at a branching position between the pump and the discharger, and returns to the tank. The first flow path forming part includes a small sectional-area part between the branching position of the first flow path and the discharger, the small sectional-area part forming a flow path having a sectional area smaller than a sectional area of the second flow path.

A portable beauty treatment device according to another aspect of the present disclosure includes the above liquid spraying device, and a grip to be held by a user.

The present disclosure can provide a liquid spraying device and a portable beauty treatment device capable of stably spraying liquid.

### BRIEF DESCRIPTION OF THE DRAWINGS

FIG. 1 shows a basic configuration of a hair care apparatus according to an exemplary embodiment;

FIG. 2A shows a basic configuration of a liquid spraying device according to the exemplary embodiment;

FIG. 2B is an enlarged view showing a configuration of a part of the liquid spraying device according to the exemplary embodiment;

FIG. 3 shows a specific configuration example of the liquid spraying device according to the exemplary embodiment;

FIG. 4 is a first diagram illustrating an operation example of the liquid spraying device based on a detection result by a detector;

FIG. 5 is a second diagram illustrating an operation example of the liquid spraying device based on the detection result by the detector;

FIG. 6 is a third diagram illustrating an operation example of the liquid spraying device based on the detection result by the detector;

FIG. 7 shows a configuration of a part of a liquid spraying device according to modification 1 of the exemplary embodiment;

FIG. 8 shows a configuration of a part of a liquid spraying device according to modification 2 of the exemplary embodiment; and

FIG. 9 is a sectional view showing a configuration of a small sectional-area part according to modification 2 of the exemplary embodiment.

### DETAILED DESCRIPTION

An exemplary embodiment of the present disclosure and modifications thereof are described below with reference to the drawings. Each of the exemplary embodiment and the modifications to be described below is intended to give a general or a specific example of the present disclosure. Numeric values, shapes, components, arrangement of the components, specific operations, orders of the operations, and the like, which are shown in the following exemplary embodiment and modifications, are merely examples, and are not intended to limit the present disclosure. Moreover, among the components in the following exemplary embodiment and modifications, components that are not described in the independent claim are described as components that can be added arbitrarily. Furthermore, the accompanied drawings are schematic diagrams which are not necessarily shown in a rigorous manner. In the drawings, the components substantially identical to each other are denoted by the same reference numerals, and repetitive descriptions may be omitted or simplified.

Although the following descriptions of the exemplary embodiment and modifications may include expressions indicating a relative direction or a relative posture, such as “parallel” and “orthogonal”, such expressions also include a direction or a posture that are not strictly the direction or the posture indicated by the expressions. For example, two directions that are parallel to each other mean not only two directions that are completely parallel to each other but also two directions substantially parallel to each other including a few percent of deviation.

### Exemplary Embodiment

Hereinafter, a hair care apparatus and a liquid spraying device according to an exemplary embodiment are described with reference to the drawings.

### [1. Hair Care Apparatus]

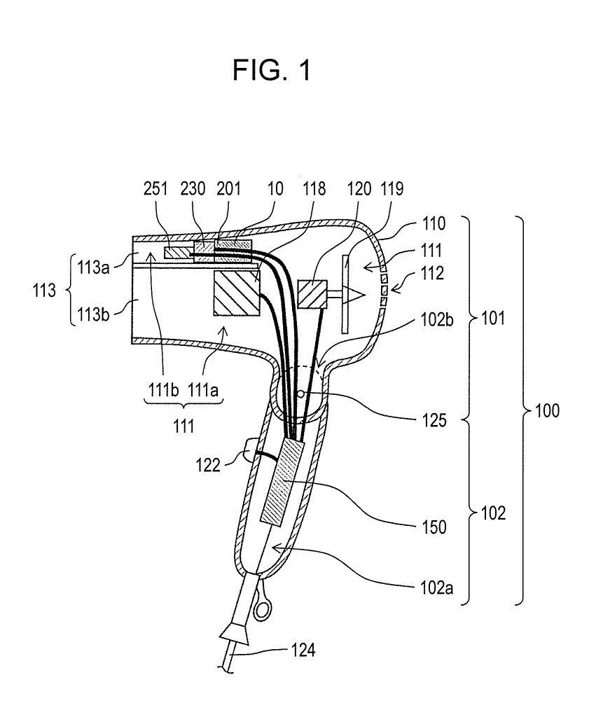

A general configuration of a hair care apparatus according to an exemplary embodiment is first described with reference to FIG. 1. FIG. 1 shows a basic configuration of hair care apparatus 100 according to the exemplary embodiment.

Hair care apparatus 100 according to the present exemplary embodiment is an example of a portable beauty treatment device, and is a hair dryer in the present exemplary embodiment.

As shown in FIG. 1, hair care apparatus 100 includes main body 101 and grip 102.

Main body 101 includes housing 110 that forms an outer frame, and housing 110 includes hollow space 111. Hollow space 111 includes blow path 111a extending from inlet 112 on one side (right side of FIG. 1) to outlet 113 on the other side (left side of FIG. 1) in a longitudinal direction (left-right direction in FIG. 1). Hollow space 111 houses various electrical components.

Grip 102, which is a part to be held by a user's hand, is joined to a lower part of housing 110 in a direction intersecting the longitudinal direction of main body 101. Main body 101 and grip 102 form a substantially T-shaped appearance or a substantially L-shaped appearance (substantially T-shaped appearance in the present exemplary embodiment) during use of hair care apparatus 100.

Grip 102 includes base 102b adjacent to main body 101, and distal end 102a. A side surface of grip 102 includes sliding power switch 122, and power cord 124 is extended from a projecting end of grip 102 (distal end 102a). Grip 102 is rotatably joined to main body 101 through connecting part 125 at base 102b. With this configuration, hair care apparatus 100 can take a folded posture such that distal end 102a is placed along main body 101.

Main body 101 includes fan 119 and motor 120, which exemplify an air blower, at an upstream position (closer to inlet 112) in blow path 111a.

Main body 101 further includes heater 118 that is disposed downstream from fan 119 (closer to outlet 113 than fan 119 is) and is configured to heat blowing air from fan 119. Heater 118 is formed by winding an electric resistor having a shape of a long strip of corrugated sheet, for example, and disposed along an inner circumference of blow path 111a.

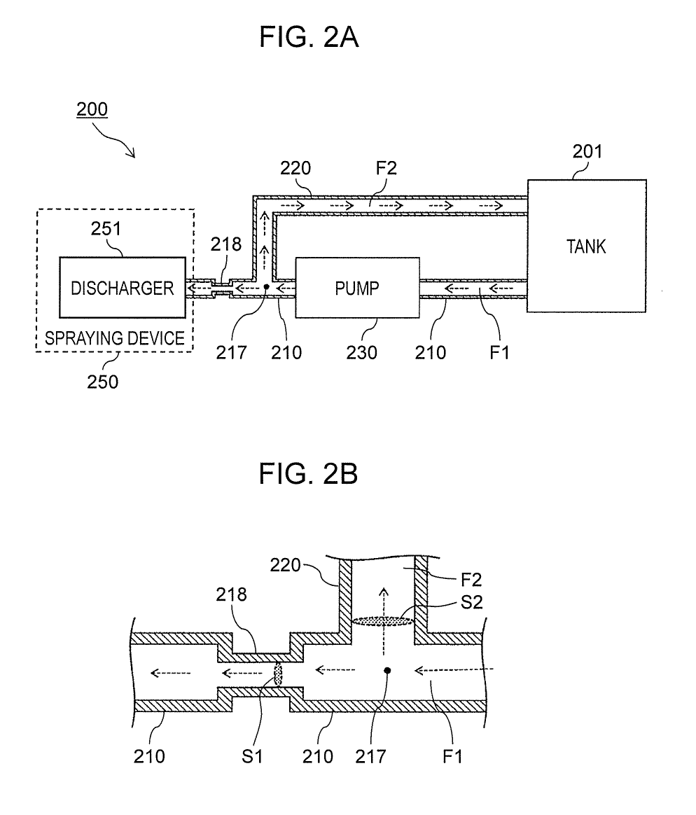

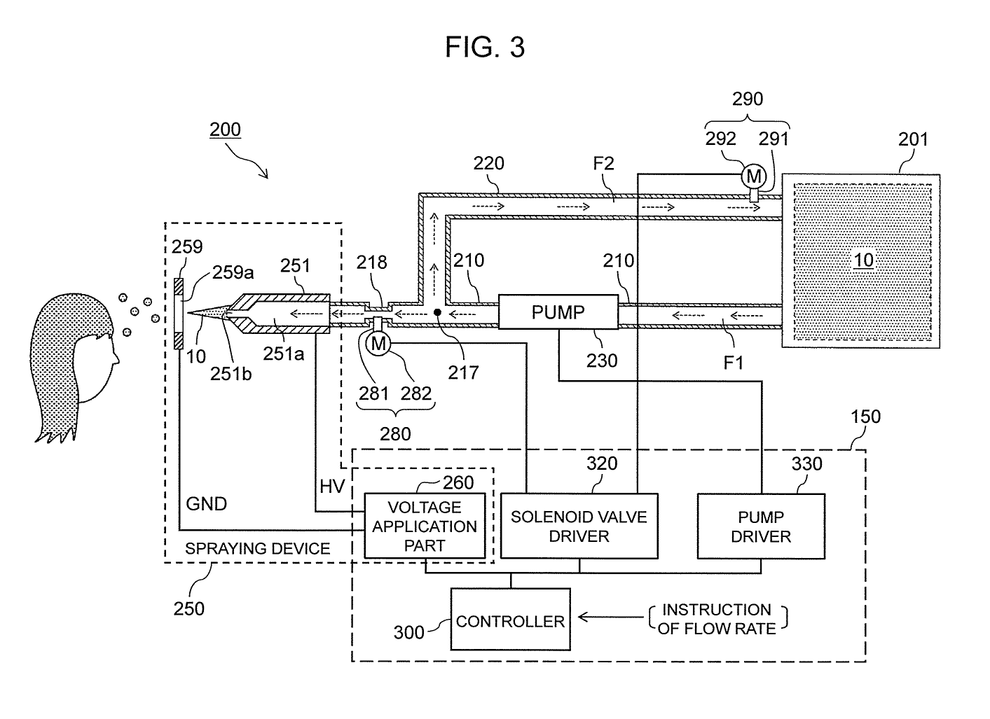

An upper side of blow path 111a includes branch path 111b separated from blow path 111a. In branch path 111b, components of liquid spraying device 200 according to the present exemplary embodiment are disposed. Specifically, branch path 111b includes tank 201 to store liquid, discharger 251 to discharge liquid in the form of a mist, and pump 230 to send out the liquid supplied from tank 201 toward discharger 251. According to the present exemplary embodiment, discharger 251 is configured to atomize the liquid by fining the liquid by discharge energy in a form of spray. A detailed configuration of liquid spraying device 200 is described below with reference to FIGS. 2A to 3.

According to the present exemplary embodiment, grip 102 or main body 101 incorporates circuit unit 150 configured to perform power supply to and operation control of components operated by electric power, such as motor 120, pump 230, and discharger 251. Electrical circuits configured to perform power supply to and operation control of each of the components may be integrated in one substrate or may be distributed on a plurality of substrates.

Basic operation of hair care apparatus 100 configured as above is described below.

When a user turns on sliding power switch 122, electric power is supplied to circuit unit 150 through power cord 124 to drive circuit unit 150.

Circuit unit 150 thus driven feeds electric current to pump 230 and discharger 251. When the electric current is supplied to pump 230, the liquid in tank 201 is supplied to discharger 251, so that the liquid is atomized and discharged from discharger 251 as a mist containing oil, medicine, and the like.

When power switch 122 is turned on, electric power is supplied to motor 120 and heater 118. As motor 120 is driven to rotate, fan 119 is rotated to form a flow of air. Specifically, the flow of air is formed such that air flowing into blow path 111a from the outside through inlet 112 passes through blow path 111a and is discharged to the outside from outlet 113. When the electric power is supplied to heater 118, air blown by fan 119 is heated. The heated air is blown to the outside from hot air outlet 113b as hot current of air and supplied to the user's hair. At this moment, the mist discharged to the outside from mist outlet 113a is supplied to the user's hair along with the flow of air discharged to the outside from outlet 113 as described above.

In the next description, liquid spraying device 200 equipped with hair care apparatus 100 configured as above is described below with reference to FIGS. 2A to 3.

### [2. Liquid Spraying Device]

First, a basic configuration and a basic operation of liquid spraying device 200 are described with reference to FIGS. 2A and 2B. FIG. 2A shows the basic configuration of liquid spraying device 200 according to the exemplary embodiment. FIG. 2B is an enlarged view showing a configuration of a part of liquid spraying device 200 according to the exemplary embodiment. Each of FIGS. 2A and 2B shows first flow path forming part 210 and second flow path forming part 220 in a sectional view parallel to the flow paths. The flow of the liquid is schematically shown by the dotted arrows, and the liquid itself is not shown in the figures. FIGS. 3 to 8 described below also illustrate the liquid and the flow paths in the same manner.

As shown in FIG. 2A, liquid spraying device 200 includes spraying device 250 with discharger 251, tank 201, first flow path forming part 210, pump 230, and second flow path forming part 220.

Tank 201 is, for example, a detachable container, and stores liquid containing oil, medicine, and the like. First flow path forming part 210 is a member disposed between tank 201 and discharger 251 and forming first flow path F1 of the liquid, and is, for example, a tubular member made of resin. Pump 230 is an electric pump provided midway of first flow path F1 and feeding the liquid from tank 201 toward discharger 251. Second flow path forming part 220 is a member forming second flow path F2 that branches off from first flow path F1 at branching position 217 between pump 230 and discharger 251 and returns to tank 201, and is, for example, a tubular member made of resin. First flow path forming part 210 may be made of a single tubular member, or may be made of a plurality of individual tubular members. The same applies to second flow path forming part 220.

As shown in FIG. 2B, first flow path forming part 210 includes small sectional-area part 218 between branching position 217 of first flow path F1 and discharger 251. Small sectional-area part 218 forms a flow path having a sectional area S1 smaller than sectional area S2 of second flow path F2. According to the present exemplary embodiment, small sectional-area part 218 is provided as a part of tubular-shaped first flow path forming part 210 of which inside diameter is smaller than the other part of first flow path forming part 210. Sectional area S2 and sectional area S1 each refer to an area of a cross section orthogonal to the flow path.

According to the present exemplary embodiment, tank 201 configured to store the liquid is a detachable (exchangeable) container, and a user exchanges tank 201 (replaces tank 201 attached to hair care apparatus 100 with new tank 201) to refill liquid spraying device 200. Tank 201 is, for example, a bag-shaped container formed of a flexible laminated film and is filled with the liquid before the exchange.

However, it is difficult to exchange tank 201 while maintaining complete airtightness of tank 201 or first flow path forming part 210, and air intrudes into first flow path forming part 210.

In such a case, air bubbles intrude in first flow path F1 extending from tank 201 toward discharger 251. In other words, air which is a compressible fluid is mixed with the liquid which is an incompressible fluid.

In the case where air bubbles mixed in the liquid are left unaddressed, even when pump 230 applies a back pressure to the liquid at a midpoint in first flow path F1, air bubbles are compressed to absorb the back pressure. This results in a situation in which the back pressure does not reach the liquid contained in discharger 251. In other words, this causes a problem in which an atomized liquid (mist) is not discharged from discharger 251 although pump 230 operates properly. In the case where the liquid is colorless and odorless, and in addition, an amount to be sprayed as a mist is small, a user cannot determine whether the mist is discharged properly from the hair care apparatus. Accordingly, even if a flow rate of pump 230 (a feeding amount of the liquid per unit time, the same shall apply hereinafter) is adjustable by the user, it is difficult to adjust the flow rate of pump 230 such that a mist is discharged properly.

In this regard, liquid spraying device 200 according to the present exemplary embodiment includes second flow path F2 extending from branching position 217 of first flow path F1 to tank 201, and also includes small sectional-area part 218 between branching position 217 and discharger 251 (see FIGS. 2A and 2B).

In other words, as viewed from branching position 217, there exist two flow paths, i.e., a flow path having a large sectional area (second flow path F2) and a flow path having a small sectional-area part (small sectional-area part 218). With this configuration, the liquid containing air bubbles travels to second flow path F2 having a smaller resistance at branching position 217, which results in exclusion of air bubbles from first flow path F1. In other words, air bubbles are released to second flow path F2.

As a result, first flow path F1 between branching position 217 and discharger 251 is filled with the incompressible fluid formed of the liquid supplied from tank 201. With this configuration, a mist is stably discharged from discharger 251 by the back pressure applied by pump 230.

Note that the back pressure applied to the fluid by pump 230 is partly lost by existence of second flow path F2. However, it is possible to apply the back pressure with a level that achieves a stable discharge of a mist to the liquid flowing from branching position 217 toward discharger 251 by adjusting in advance a flow rate of pump 230 in view of the lost due to the existence of second flow path F2.

Next, specific configuration examples and operation examples of liquid spraying device 200 according to the present exemplary embodiment are described with reference to FIGS. 3 to 6.

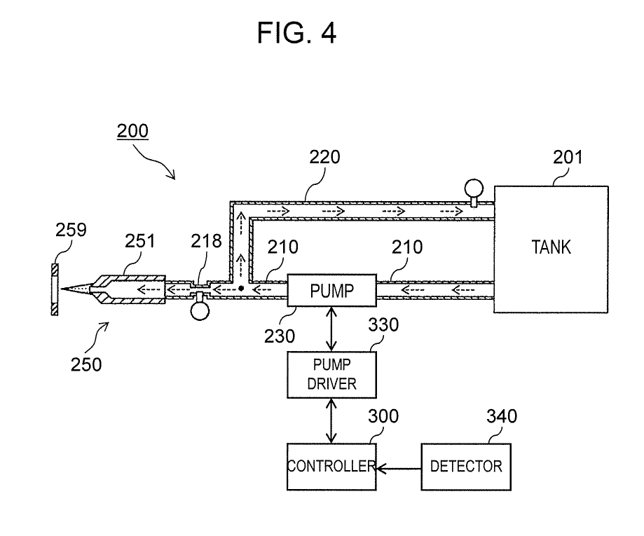

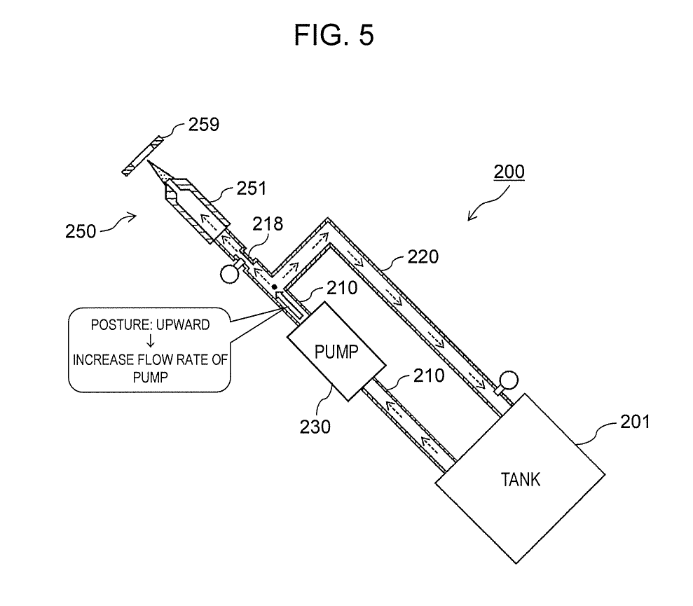

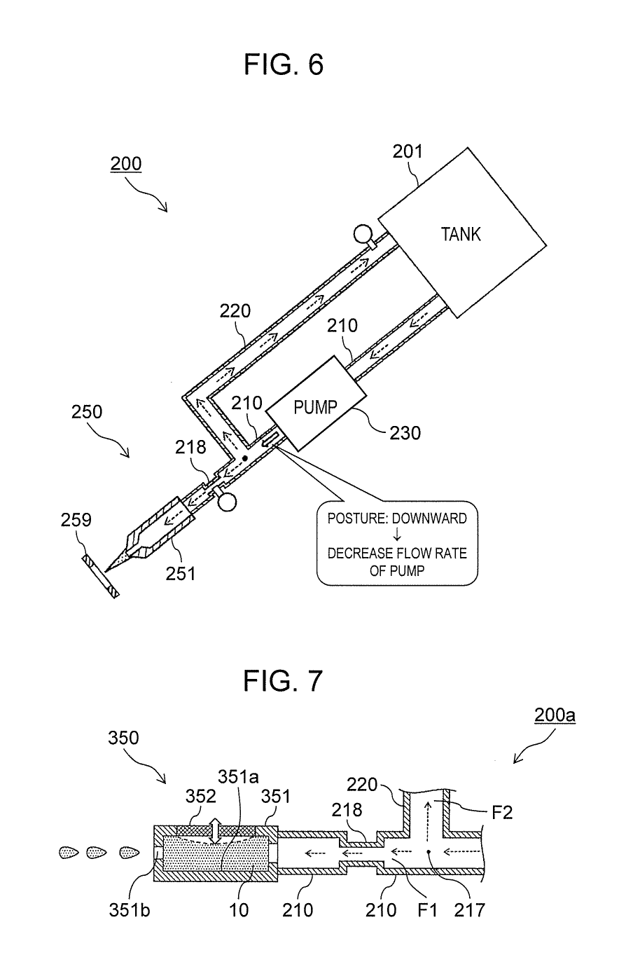

FIG. 3 shows a specific configuration example of liquid spraying device 200 according to the exemplary embodiment. FIGS. 4 to 6 are first to third diagrams each illustrating an operation example of liquid spraying device 200 based on a detection result by detector 340. FIG. 4 shows a configuration example focusing on detector 340 and controller 300, and components that are in no need of explanation are omitted in the figure. FIGS. 5 and 6 each show an example of a posture of liquid spraying device 200, and the figures show the components concerning formation of the flow paths of the liquid, such as discharger 251, pump 230, and tank 201, and omit other components.

As shown in FIG. 3, liquid spraying device 200 includes, in addition to the components shown in FIG. 2A, solenoid valve 280 and solenoid valve 290, voltage application part 260, solenoid valve driver 320, pump driver 330, and controller 300. According to the present exemplary embodiment, voltage application part 260, solenoid valve driver 320, pump driver 330, and controller 300 are included in circuit unit 150 that is incorporated in grip 102. Voltage application part 260, solenoid valve driver 320, and pump driver 330 operate independently in accordance with instructions from controller 300. Various information processing implemented by controller 300 described below are achieved when an arithmetic unit (such as a central processing unit (CPU)) executes a predetermined program read out from a storage device such as a memory.

Solenoid valve 280 is an example of an on-off valve, and is disposed at a position of small sectional-area part 218 according to the present exemplary embodiment. Solenoid valve 280 includes movable part 281 that operates to close first flow path F1, and driver 282 such as a motor configured to drive movable part 281. Solenoid valve 290 is disposed midway of second flow path F2. Solenoid valve 290 includes movable part 291 that operates to close second flow path F2, and driver 292 such as a motor configured to drive movable part 291.

Operations of solenoid valve 280 and solenoid valve 290 are controlled by solenoid valve driver 320. For example, when power switch 122 is turned on from off, solenoid valve driver 320 controls solenoid valves 280 and 290 to open the respective flow paths. Specifically, solenoid valve driver 320 operates (moves or rotates) movable part 281 that has been in a closing state to close first flow path F1 to be shifted to an opening state to open first flow path F1. In the same manner, solenoid valve 290 operates under control of solenoid valve driver 320 and movable part 291 is shifted to an opening state to open second flow path F2.

At this time, pump driver 330 starts to operate pump 230. Pump 230 is supplied with liquid 10 stored in tank 201. With this configuration, the back pressure applied by pump 230 acts on liquid 10 disposed closer to discharger 251 than solenoid valve 280 is, and then discharger 251 starts discharging a mist.

When power switch 122 is switched from on to off, solenoid valve driver 320 controls solenoid valve 280 and solenoid valve 290 to close flow paths. Specifically, solenoid valve driver 320 operates (moves or rotates) movable part 281 that has been in the opening state to open first flow path F1 to be shifted to the closing state to close first flow path F1. In the same manner, solenoid valve 290 operates under control of solenoid valve driver 320 and movable part 291 is shifted to the closing state to close second flow path F2.

At this time, pump driver 330 stops to operate pump 230. This causes pump 230 to suspend application of the back pressure to liquid 10, and places liquid 10 disposed closer to discharger 251 than solenoid valve 280 is in a condition not to leak from discharger 251 due to an atmospheric pressure.

Spraying device 250 according to the present exemplary embodiment includes discharger 251, induction electrode 259, and voltage application part 260. Discharger 251 is formed of a conductive material such as brass. Discharger 251 includes storage chamber 251a configured to store liquid 10 supplied through first flow path F1, and outflow port 251b configured to flow liquid 10 stored in storage chamber 251a to the outside. Application of the back pressure through first flow path F1 allows liquid 10 stored in storage chamber 251a to flow out from outflow port 251b. Liquid 10 flown out from outflow port 251b is made into a mist (atomized) by discharging energy. Specifically, a voltage is applied between induction electrode 259 and discharger 251 so that liquid 10 is atomized and discharged.

Induction electrode 259 is a member disposed at a position facing outflow port 251b of discharger 251 and formed of a conductive material such as a metal. Induction electrode 259 includes opening 259a configured to discharge a mist.

Voltage application part 260 applies a voltage between discharger 251 and induction electrode 259 when power switch 122 is turned on from off. For example, induction electrode 259 is grounded through voltage application part 260, and voltage application part 260 applies a positive voltage to discharger 251. This generates an electric discharge between discharger 251 and induction electrode 259, and liquid 10 flown out from outflow port 251b of discharger 251 is made into a mist (atomized) by discharging energy. A positively charged mist is blown toward induction electrode 259, and is discharged to the outside through opening 259a of induction electrode 259. At this time, liquid 10 flown out from outflow port 251b forms a Taylor cone. The Taylor cone is a part formed by liquid 10 having a spindle shape or a conical shape, of which bottom surface is formed by a part of liquid 10 attaching to and expanded around a peripheral edge of outflow port 251b.

In this manner, the positively charged mist discharged from opening 259a of induction electrode 259 is supplied to the user's hair, which is negatively charged, along with the flow of air discharged from outlet 113 of hair care apparatus 100 (see FIG. 1).

According to liquid spraying device 200 configured as described above, a discharging amount of a mist can be adjusted by magnitude of the back pressure applied by pump 230. In other words, a discharging amount of a mist can be adjusted by adjusting a flow rate of pump 230.

Here, suppose that hair care apparatus 100 is positioned such that outlet 113 is directed vertically upward, i.e., a flowing direction of liquid 10 in first flow path F1 of liquid spraying device 200 is directed vertically upward. In this case, liquid spraying device 200 is required to discharge a mist in a vertically upward direction. Hair care apparatus 100 is a portable beauty treatment device to be used in a user's hand, and thus may be put in various postures during use. Accordingly, it is necessary to ensure a discharging amount (e.g., a minimum required amount) of a mist in a posture in which discharging of a mist is most difficult.

Therefore, in liquid spraying device 200, a flow rate of pump 230 is adjusted such that the back pressure is applied to liquid 10 at a level that enables discharging of a minimum required amount of a mist in a vertically upward direction. For example, a flow rate of pump 230 is adjusted in view of a gross weight of liquid 10 existing closer to discharger 251 than pump 230 is, a channel resistance at a part closer to discharger 251 than pump 230 is, and the like. This ensures a discharging amount of a mist, for example, required for protection or improvement of hair quality of a user, even when hair care apparatus 100 is used in any postures.

In addition, second flow path F2 may be closed by operating solenoid valve 290, for example, when hair care apparatus 100 is put in a posture in which outlet 113 is directed vertically upward. This configuration suppresses an amount of loss in the back pressure in first flow path F1 due to the existence of second flow path F2, which allows the back pressure applied to liquid 10 by pump 230 to be efficiently used for discharging of a mist.

According to the present exemplary embodiment, tank 201 is a bag-shaped container formed of a flexible laminated film as described above. Thus, an elastic member such as a spring may be disposed such that an urging force is applied to a side surface of tank 201. This ensures inflow of liquid 10 into first flow path F1 from tank 201, even when liquid spraying device 200 is used in any postures.

A flow rate of pump 230 during a time of power-on is not necessarily constant, and may be changed, for example, according to a user's instruction acquired by controller 300 through a switch, a dial, or the like. In other words, a discharging amount of a mist from hair care apparatus 100 may be changed according to an instruction from the user.

In addition, a posture of hair care apparatus 100 (or liquid spraying device 200) may be detected by using a sensor or the like, so that a discharging amount of a mist can be adjusted according to the detected result.

For example, as shown in FIG. 4, hair care apparatus 100 includes detector 340 configured to detect a posture of liquid spraying device 200. Detector 340 is a sensor, such as an acceleration sensor or a gyroscope, configured to detect a tilt of an object. Controller 300 of liquid spraying device 200 can determine a current posture of liquid spraying device 200 by acquiring the detection result by detector 340.

Detector 340 outputs to controller 300 the detection result indicating, for example, whether liquid spraying device 200 is put in a posture in which discharger 251 is positioned higher than tank 201 in a vertical direction. In short, detector 340 outputs to controller 300 the detection result indicating whether liquid spraying device 200 is directed upward.

For example, when liquid spraying device 200 is directed upward as shown in FIG. 5, controller 300 acquires from detector 340 the detection result indicating that liquid spraying device 200 is directed upward. In this case, controller 300 controls pump driver 330 so as to increase a flow rate of pump 230.

On the other hand, when controller 300 determines that liquid spraying device 200 is not directed upward (e.g., discharger 251 is placed equal to or lower than tank 201 in the vertical direction), controller 300 controls pump driver 330 such that a flow rate of pump 230 becomes V1. In addition, when controller 300 determines that liquid spraying device 200 is directed upward, controller 300 controls pump driver 330 such that a flow rate of pump 230 becomes V2 (V2>V1).

With this configuration, the back pressure applied to liquid 10 by pump 230 can be increased when liquid spraying device 200 is directed upward, and as a result, a mist is stably discharged. When liquid spraying device 200 is directed upward, second flow path F2 may be closed by operating solenoid valve 290 as described above. This allows the back pressure applied to liquid 10 by pump 230 to be efficiently used for discharging of a mist.

Controller 300 can change a flow rate of pump 230 when controller 300 determines that liquid spraying device 200 is directed downward.

Detector 340 outputs to controller 300 the detection result indicating, for example, whether liquid spraying device 200 is put in a posture in which discharger 251 is positioned lower than tank 201 in the vertical direction. In short, detector 340 outputs to controller 300 the detection result indicating whether liquid spraying device 200 is directed downward.

For example, when liquid spraying device 200 is directed downward as shown in FIG. 6, controller 300 acquires from detector 340 the detection result indicating that liquid spraying device 200 is directed downward. In this case, controller 300 controls pump driver 330 so as to decrease a flow rate of pump 230.

In other words, when controller 300 determines that liquid spraying device 200 is not directed downward (e.g., discharger 251 is placed equal to or higher than tank 201 in the vertical direction), controller 300 controls pump driver 330 such that a flow rate of pump 230 becomes V1. In addition, when controller 300 determines that liquid spraying device 200 is directed downward, controller 300 controls pump driver 330 such that the flow rate of pump 230 becomes V3 (V3<V1).

With this configuration, in a case where liquid spraying device 200 is directed downward, the back pressure applied to liquid 10 by pump 230 can be decreased, which suppresses an unnecessary increase in a discharging amount of a mist.

Controller 300 may change the flow rate of pump 230 in multiple levels according to the detection result from detector 340. For example, the flow rate of pump 230 may be increased or decreased with reference to flow rate Vs of pump 230 when liquid spraying device 200 is in a horizontal posture (e.g., discharger 251 and tank 201 are positioned at the same level in the vertical direction). In other words, as an upward angle (an angle of elevation) of liquid spraying device 200 increases, the flow rate of pump 230 is increased relative to flow rate Vs, and as a downward angle (an angle of depression) of liquid spraying device 200 increases, the flow rate of pump 230 is decreased relative to flow rate Vs. With this configuration, the back pressure applied to liquid 10 by pump 230 can be changed following the change of the posture, even when liquid spraying device 200 is put in any postures. As a result, a discharging amount of a mist is stably maintained with high accuracy independently from the posture of liquid spraying device 200 (hair care apparatus 100).

As described above, liquid spraying device 200 according to the present exemplary embodiment includes tank 201 configured to store liquid 10, spraying device 250 including discharger 251 configured to discharge liquid 10 in a form of a mist, first flow path forming part 210 that is disposed between tank 201 and discharger 251 and forms first flow path F1 of liquid 10, pump 230 that is provided midway of first flow path F1, and feeds liquid 10 from tank 201 toward discharger 251, and second flow path forming part 220 configured to form second flow path F2 that branches off from first flow path F1 at branching position 217 between pump 230 and discharger 251, and returns to tank 201. First flow path forming part 210 includes small sectional-area part 218 between branching position 217 of first flow path F1 and discharger 251. Small sectional-area part 218 forms a flow path having a sectional area smaller than the sectional area of second flow path F2.

With this configuration, liquid spraying device 200 includes second flow path F2 branching from branching position 217 of first flow path F1, and includes small sectional-area part 218 at a position closer to discharger 251 than branching position 217 is. Accordingly, even when air bubbles intrude into first flow path F1, for example, the air bubbles can be released to second flow path F2. As a result, first flow path F1 between branching position 217 and discharger 251 is filled with the incompressible fluid formed of liquid 10 supplied from tank 201. With this configuration, a mist is stably discharged from discharger 251 by the back pressure applied by pump 230. Thus, liquid spraying device 200 according to the present exemplary embodiment can stably spray liquid 10.

In addition, liquid spraying device 200 according to the present exemplary embodiment includes controller 300 configured to control an operation of pump 230 so as to change a feeding amount of liquid 10 by pump 230.

With this configuration, the back pressure applied to liquid 10 which is fed by pump 230 toward discharger 251 can be controlled by controller 300. With this configuration, the back pressure applied to liquid 10 by pump 230 can be adjusted according to, for example, characteristics of liquid 10 such as viscosity, a working state or working environment of liquid spraying device 200, a user's instruction, or the like. As a result, a stable discharge of a mist from discharger 251 is reliably achieved.

According to liquid spraying device 200 of the present exemplary embodiment, controller 300 increases a feeding amount of liquid 10 by pump 230 when controller 300 acquires a detection result from detector 340 that detects a posture of liquid spraying device 200, and the detection result indicates that liquid spraying device 200 is in an upward posture.

With this configuration, when liquid spraying device 200 is directed upward, i.e., discharging of a mist becomes difficult as the gravity acts on liquid 10, the back pressure applied to liquid 10 by pump 230 can be increased, and as a result, a mist is stably discharged.

According to liquid spraying device 200 of the present exemplary embodiment, discharger 251 includes storage chamber 251a to store liquid 10, and outflow port 251b to allow liquid 10 stored in storage chamber 251a to flow out to the outside. Spraying device 250 further includes induction electrode 259 disposed at a position facing outflow port 251b of discharger 251, and voltage application part 260 configured to apply a voltage between discharger 251 and induction electrode 259.

With this configuration, liquid 10 to be sprayed (i.e., a mist) can be positively charged, for example, thereby allowing the mist to be easily attached to the negatively charged user's hair. As a result, a mist containing oil, medicine, and the like can be efficiently supplied to the user's hair. Since droplets forming a mist are positively charged, for example, cohesion of the droplets hardly occurs, so that atomization of the droplets is facilitated. With this configuration, a mist can be supplied uniformly to a relatively wide area.

Hair care apparatus 100 according to the present exemplary embodiment includes liquid spraying device 200 and grip 102 to be held by a user.

This configuration achieves hair care apparatus 100 that is a device to be held by a user's hand and used in various postures, and also achieves hair care apparatus 100 that enables stably discharging of a mist.

The configuration of liquid spraying device 200 included in hair care apparatus 100 is not limited to the configuration described in the above exemplary embodiment. In the next description, modifications of liquid spraying device 200 are described focusing on differences from the above exemplary embodiment.

### (Modification 1)

FIG. 7 shows a configuration of a part of liquid spraying device 200a according to modification 1 of the exemplary embodiment. Liquid spraying device 200a shown in FIG. 7 includes spraying device 350 instead of spraying device 250.

Spraying device 350 includes discharger 351 to which liquid 10 is supplied through first flow path F1. This configuration is common to spraying device 250 according to the above exemplary embodiment. However, spraying device 350 according to the present modification differs from spraying device 250 according to the above exemplary embodiment in a method of generating a mist.

Specifically, according to this modification, discharger 351 includes storage chamber 351a to store liquid 10, and discharging port 351b configured to discharge liquid 10 stored in storage chamber 351a to the outside. Spraying device 350 further includes pressurization part 352 configured to repeatedly pressurize liquid 10 stored in storage chamber 351a in an inward direction of storage chamber 351a.

Pressurization part 352 is a piezoelectric element, for example, and is disposed as a part of a wall that forms storage chamber 351a. Receiving a predetermined voltage, pressurization part 352, which is the piezoelectric element, deforms to press liquid 10 stored in storage chamber 351a, so that liquid 10 is discharged from discharging port 351b in a form of fine droplets. As the application of the voltage to the piezoelectric element is repeated intermittently, the piezoelectric element vibrates in a thickness direction (vertical direction in FIG. 7), so that atomized liquid 10 (i.e., a mist) is put in a condition ready to be discharged from discharging port 351b. In addition, as shown in FIG. 1, for example, hair care apparatus 100 includes an air blower (fan 119 and motor 120), thus a mist discharged from discharging port 351b is supplied to the user's hair along with the flow of air discharged from outlet 113 to the outside.

In other words, discharger 351 according to this modification is a device configured to generate droplets using so-called inkjet techniques. Even with such techniques, liquid 10 is stably supplied to discharger 351 due to a back pressure applied to liquid 10 by pump 230 (see FIG. 3), thereby allowing discharger 351 to stably discharge a mist.

Note that a heater configured to heat liquid 10 stored in storage chamber 351a may be employed as pressurization part 352. In such a case, pressurization part 352, which is the heater, instantly heats liquid 10, thereby boiling liquid 10 to generate air bubbles in liquid 10. As a result, liquid 10 is pressurized by the air bubbles inside storage chamber 351a, and droplets are discharged from discharging port 351b. Since this operation is repeatedly performed, atomized liquid 10 (i.e., a mist) is put in a condition ready to be discharged from discharging port 351b. As described above, pressurization part 352 may be a component configured to pressurize liquid 10 by generating air bubbles in liquid 10.

### (Modification 2)

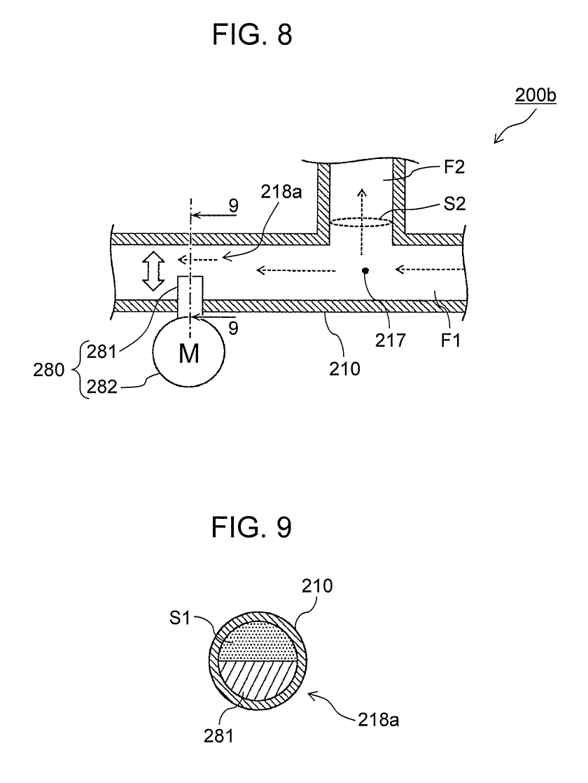

FIG. 8 shows a configuration of a part of liquid spraying device 200b according to modification 2 of the exemplary embodiment. FIG. 9 is a sectional view showing a configuration of small sectional-area part 218 according to modification 2 of the exemplary embodiment. Specifically, FIG. 9 is a sectional view of an interior of first flow path forming part 210 taken along line 9-9 of FIG. 8, and a section of the flow path that allows liquid 10 to pass is indicated with dots.

According to liquid spraying device 200b of this modification, first flow path forming part 210 includes small sectional-area part 218a between branching position 217 of first flow path F1 and discharger 251. Small sectional-area part 218a forms a flow path having sectional area S1 smaller than sectional area S2 of second flow path F2. This configuration is common to liquid spraying device 200 according to the above exemplary embodiment.

However, small sectional-area part 218a according to this modification differs from liquid spraying device 200 according to the above exemplary embodiment in that small sectional-area part 218a is formed by solenoid valve 280.

Specifically, small sectional-area part 218a includes solenoid valve 280, and solenoid valve 280 includes movable part 281 that operates to close first flow path F1, and driver 282 configured to drive movable part 281.

With the above configuration, movable part 281 is in a projected state in which, for example, movable part 281 is projected to about half of an inside diameter of tubular-shaped first flow path forming part 210 during a normal operation of liquid spraying device 200b, as shown in FIGS. 8 and 9. This configuration enables formation of a flow path having sectional area S1 that is smaller than sectional area S2 of second flow path F2. As described above, when power switch 122 is switched from on to off, for example, movable part 281 can be shifted to a closing state to close first flow path F1 according to an instruction from controller 300.

A degree of closing of first flow path F1 by solenoid valve 280 is adjusted as described above, so that small sectional-area part 218a can be provided by solenoid valve 280 and, for example, first flow path F1 can be closed during a period in which discharging of a mist is not required.

The degree of closing of first flow path F1 by solenoid valve 280 can be adjusted in three or more levels. In other words, driver 282 may operate movable part 281 in at least three levels, i.e., a closing state to close first flow path F1, an opening state to open first flow path F1, and a partly closing state to partly close first flow path F1.

With reference to FIG. 9, the closing state is a state in which S1 is zero, the opening state is a state in which S1 coincides with a sectional area of the interior of first flow path forming part 210, and a partly closing state is a state in which S1 is larger than zero and smaller than the sectional area of the interior of first flow path forming part 210.

Sectional area S1 in small sectional-area part 218a can be changed (adjusted) by operating solenoid valve 280 in multiple levels as described above. This can increase or decrease an amount of liquid 10 to be supplied to discharger 251 (see FIG. 3) per unit time, for example. As a result, a discharging amount of a mist is changed. In other words, an amount of a mist to be discharged from hair care apparatus 100 may be adjusted by changing the degree of closing of first flow path F1 by solenoid valve 280.

In this case, controller 300 may acquire a detection result from detector 340 (see FIG. 4) to control solenoid valve 280 according to the acquired detection result. For example, when the detection result indicates that liquid spraying device 200b is directed upward, controller 300 may control solenoid valve 280 so as to increase sectional area S1 in small sectional-area part 218a. On the other hand, for example, when the detection result indicates that liquid spraying device 200b is directed downward, controller 300 may control solenoid valve 280 so as to decrease sectional area S1 in small sectional-area part 218a. Operation control of solenoid valve 280 may be performed as described above to stabilize a discharge of a mist. Such operation control of solenoid valve 280 may be performed together with controlling of a flow rate of pump 230 based on the detection result by detector 340. With this configuration, stabilization of a discharge amount of a mist from liquid spraying device 200b is attained more reliably, for example, when the posture of liquid spraying device 200b (hair care apparatus 100) is changed variously.

The above effect caused by the operation of solenoid valve 280 is also provided with a case in which solenoid valve 280 is disposed in small sectional-area part 218 that is a part with an inner diameter smaller than the other parts in tubular-shaped first flow path forming part 210 as in the above exemplary embodiments.

### Other Exemplary Embodiments

As described above, the exemplary embodiment and modifications thereof have been described as examples of techniques according to the present disclosure. However, the present disclosure is not limited thereto, and various changes, substitutions, additions, omissions, and the like can be made as appropriate.

For example, although liquid 10 to be atomized includes oil, medicine, and the like, according to the above exemplary embodiment, kinds of the components contained in liquid 10 are not limited. For example, in the case where liquid spraying device 200 is equipped to the portable beauty treatment device to supply a mist to human skin, liquid 10 may be any liquid containing medicine or the like appropriate for moisture keeping or improvement of a quality of the skin.

Note that it is preferable that liquid 10 has a viscosity appropriate for atomization by liquid spraying device 200 (e.g., a viscosity almost the same as water).

In addition, a material of tank 201 configured to store liquid 10 may be a material other than a laminated film. For example, a rigid resin material or a metal material having tolerance to liquid 10 may be employed as a material of tank 201.

Tank 201 is not necessarily detachable. In other words, tank 201 may be fixed instead of detachable to liquid spraying device 200. In such a case, tank 201 is equipped with an openable liquid pouring port, so that tank 201 can be refilled with liquid 10 from the liquid pouring port by using a syringe or the like.

Hair care apparatus 100 as a portable beauty treatment device equipped with liquid spraying device 200 may be an apparatus different from a hair dryer. For example, a hair iron may be employed as hair care apparatus 100.

Each of first flow path forming part 210 and second flow path forming part 220 is not necessarily a tubular-shaped member. For example, a passage for allowing liquid 10 to pass may be provided inside a resin mass to form first flow path forming part 210 and second flow path forming part 220.

Although the liquid spraying device and the portable beauty treatment device according to the present disclosure have been described based on the exemplary embodiment and modifications, the scope of the present disclosure is not limited to the above exemplary embodiment and modifications. Without departing from the spirit of the present disclosure, a variety of modifications conceived by those skilled in the art and applied to the exemplary embodiment or the modifications, and another embodiment constructed by combining some constituents in the exemplary embodiment or the modifications is also included within the scope of the present disclosure.

The liquid spraying device and the portable beauty treatment device according to the present disclosure may be applied to electrical equipment such as a hair dryer and a hair iron.

What is claimed is:

1. A liquid spraying device comprising:
a tank configured to store liquid;
a spraying device including a discharger configured to discharge the liquid in a form of a mist;
a first flow path forming part that is disposed between the tank and the discharger and forms a first flow path of the liquid;
a pump that is provided midway of the first flow path, and feeds the liquid from the tank toward the discharger; and
a second flow path forming part configured to form a second flow path that branches off from the first flow path at a branching position between the pump and the discharger, and returns to the tank,
wherein the first flow path forming part includes a small sectional-area part between the branching position of the first flow path and the discharger, the small sectional-area part forming a flow path having a sectional area smaller than a sectional area of the second flow path.

2. The liquid spraying device according to claim 1, further comprising a controller configured to control an operation of the pump so as to change a feeding amount of the liquid by the pump.

3. The liquid spraying device according to claim 2, wherein the controller increases the feeding amount of the liquid by the pump when the controller acquires a detection result from a detector that detects a posture of the liquid spraying device, and the detection result indicates that the liquid spraying device is in an upward posture.

4. The liquid spraying device according to claim 1,
wherein the small sectional-area part includes an on-off valve, and
wherein the on-off valve includes a movable part that operates to close the first flow path, and a driver configured to drive the movable part.

5. The liquid spraying device according to claim 4, wherein the driver operates the movable part in at least three levels including:
a closing state to close the first flow path;
an opening state to open the first flow path; and
a partly closing state to partly close the first flow path.

6. The liquid spraying device according to claim 1,
wherein the discharger includes:
a storage chamber configured to store the liquid; and
an outflow port configured to allow the liquid in the storage chamber to flow out to an outside, and
wherein the spraying device further includes:
an induction electrode disposed at a position facing the outflow port of the discharger; and
a voltage application part configured to apply a voltage between the discharger and the induction electrode.

7. The spraying device according to claim 1,
wherein the discharger includes:
a storage chamber configured to store the liquid, and
a discharging port configured to discharge the liquid in the storage chamber to an outside, and
wherein the spraying device further includes a pressurization part configured to repeatedly pressurize the liquid stored in the storage chamber in an inward direction of the storage chamber.

8. A portable beauty treatment device comprising:
the liquid spraying device according to claim 1; and
a grip to be held by a user.
